(19) United States
(12) Patent Application Publication
(10) Pub. No.: US 2021/0214578 A1
(43) Pub. Date: Jul. 15, 2021

(54) METHOD FOR STRENGTHENING A BIODEGRADABLE OR COMPOSTABLE SUBSTRATE USING ANNEALING WAX PROCESS

(71) Applicant: Smart Wipes, LLC d/b/a Hyge Products, LLC, Grand Rapids, MI (US)

(72) Inventors: Anthony M. Bird, Grand Rapids, MI (US); Brent A. Saulic, Grand Rapids, MI (US)

(73) Assignee: Smart Wipes, LLC d/b/a Hyge Products, LLC

(21) Appl. No.: 17/146,469

(22) Filed: Jan. 11, 2021

Related U.S. Application Data
(60) Provisional application No. 62/959,567, filed on Jan. 10, 2020.

(51) Int. Cl. C09D 191/06; B05D 1/18; D21J 1/08; D21J 1/12

(52) U.S. Cl. CPC C09D 191/06; D21J 1/12; D21J 1/08; B05D 1/18

(57) ABSTRACT

A method for coating an article using a wax solution for providing strength to its structure while formulating the wax so it is biodegradable and compostable after the article is spent. The method using an annealing process of rapidly cooling the wax to increase its strength to a desired hardness.

### FIELD OF THE INVENTION

The present invention relates generally to a formula and method for producing a biodegradable wax solution used for strengthening a substrate.

### BACKGROUND

In the market today, there exists an abundance of plastic-based containers for a wide variety of everyday consumer products. These containers advertise ‘recyclability’ for the sake of consumer sentiment with regards to protecting the environment and maintaining sustainable systems of consumption. However, data show that these containers have little to no actual recourse for full recyclability when it comes to usage in the U.S. Further, plastics and plastic-based substrates are known to not biodegrade under normal conditions. Given this state of affairs, it was important to develop an alternative material to plastic, which possesses similar degrees of durability and economic feasibility as plastic or plastic based substrates do, but also possesses proper biodegradability, removing any dependency from a recycling process perspective.

While developing products which require a biodegradable case/container, problems were evident relating to non-resistance of non-water-only solutions that are contained within a case/container. This issue causes the solution, or some of its ingredients, to penetrate the substrate of the case/container. The overall effect is to compromise the container's structural integrity. Other materials that exist on the market, which improve resistance to the types of substrates used, are not biodegradable (e.g. polyepolyethylene). This necessitated the development of a process to strengthen the biodegradable substrate to prevent the penetration of non-water-only solutions for a long enough period of time to allow for ideal usage, whilst keeping it biodegradable. To achieve this process for strengthening, new solutions need to be developed.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a flow chart diagram illustrating steps and decision points which represent a variation in preference of the desired properties for a wax product.

FIG. 2 is a flow chart illustrating the generalized process using the steps of Wax Annealing.

FIG. 3 is a flow chart showing how the Wax Solution is created from constituent ingredients.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps relating to strengthening a biodegradable (and/or compostable) substrate using an annealing wax process (Wax Annealing). Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Wax has been used in many industries to achieve various product refinements. However, wax alone as a base or treatment to substrates is not sufficient for usage because of its brittleness, low melting point, difficulties of application as well as various other constraints. To improve on this, the present invention is a wax-based composition (“Wax Solution”) where various ingredients are used to change the properties of the wax base. Additionally, a method wherein this Wax Solution is added, compacted, re-heated, cooled, treated, and optionally reapplied to the substrate (termed “Annealing”) to achieve the preferred non-water-only solution resistance (by altering surface characteristics and solidified structural form of the fused wax-substrate composition) and durability has been developed. This process can be applied to a biodegradable substrate to arbitrarily improve its strength based on the use case needed.

The present invention introduces such a method for developing the substrate and any containers or products developed from such a method via a robust and iterative strengthening process. One or more methods are disclosed for combining variants of higher alkanes, fatty acids, and lipids (“Wax Solution”) with biodegradable or compostable substrates through specialized method steps or a process (“Process”). The Process is used to manufacture and produce arbitrarily shaped/formed containers or articles that are resistant to water and non-water-based solution and have improved durability. The containers or articles are not permeated by the non-water-only solution and the container will not corrode, degrade, or become structurally compromised within a reasonable amount of time (i.e. an average number of usage cycles by a consumer of the container or article, post introduction of the non-water-only solution to the container or article.

The processes as described herein include a number of variants namely;
(1) Resistance to various solutions;
(2) Improved Durability
(3) Various wax mixture ratio properties;
(4) Dependence between Substrate, Design, and Coating Process; and
(5) Hermeticity of a biodegradable container.

Various terms of art are used herein to better define the processes of the invention and include but are not limited to:

Resistant/Resistive: able to withstand direct contact water-based or non-water-based solutions containing: surfactants, detergent, soaps, cleaning agents, or other emulsions or suspensions, in a room temperature environment for longer than 30 days without permeation (or with partial, non-structurally-comprising permeation), outward-facing corrosion, degradation of or structurally comprising the article, container, or Substrate.

Durability: Higher than average toughness, strength, elasticity, ductility, toughness and wear resistance.

Substrate: the arbitrarily formed, composite material for which the coating is applied to achieve a Resistive container.

Further, a number of variables are used in the formulation of the invention and include:
Tₛₒₗᵤₜᵢₒₙ is: Temperature of wax solution
T_{congealing} is: Congealing point of wax solution
t_{application} is: Elapsed time the article is coated or submerged in wax solution
T_{cooling} is: Temperature range maintained while working
t_{cooling} is: Cooling time window available for working
∂ₛₒₗᵤₜᵢₒₙ is: Solution's mixture distribution
πₛₒₗᵤₜᵢₒₙ is: Adhesion (to substrate) of wax solution

Mixing Ratios and Mixing Process of the Wax Solution:

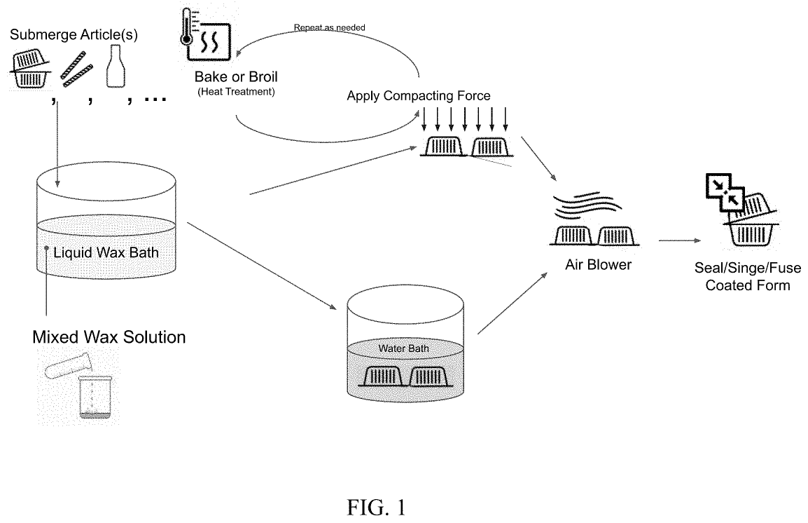

FIG. 1 is a flow chart diagram of the processes that illustrate the critical path and decision points which represents variations in preferences of the desired properties of the final, wax-annealed product. By combining waxes of various melting points, viscosity, density, adhesiveness, elasticity, and topological surface properties and mixing them to an even distribution, a Wax Solution is created which can be applied to biodegradable or compostable substrates while the Wax Solution is at or around it's melting or congealing temperature (or pour point).

One option shown in FIG. 1 is the ‘Wax Bath’ method, wherein the substrate is fully submerged into the Wax Solution.

The ingredients comprising the Wax Solution include but are not limited to:
1) Wax Base (Paraffin, Soy, Beeswax, Palm, Slack, Scale, or others);
2) Microcrystalline Waxes,
3) Fatty Acids; and
4) Higher Alkanes.

Coating Process (Wax Annealing)

Different properties of the final coated substrate, such as a container or other article, can be achieved based on the process of: wax application, heating, cooling, applying a compacting force (F_{compacting}), re-heating (Heat Treatment), wax re-application, repeating this as desired. In this document, this term will be referred to as the process of “Wax Annealing”. One such annealing process option is to simply coat the substrate and place it in a water bath at SATP. In this case, this is simply an example used for a means of a ‘Rapid Cooling’ step which hardens the surface based on the temperature of cooling e.g. T_{cooling} and the rate of cooling, V_{cooling}.

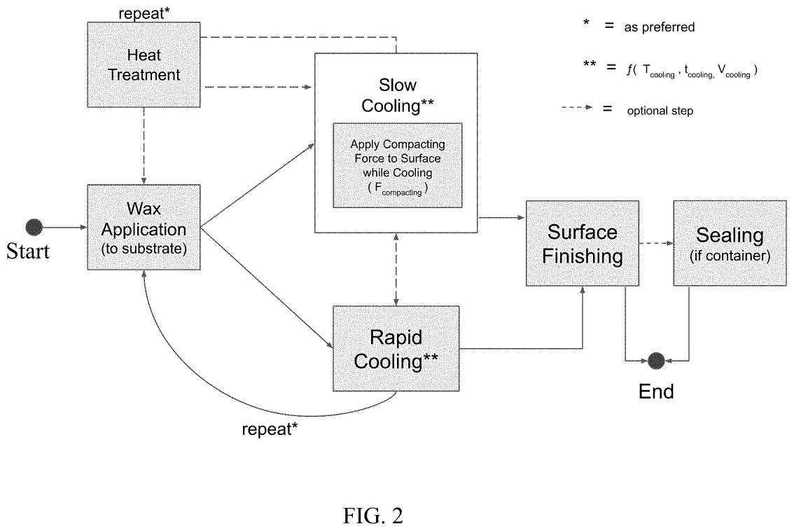

As seen in FIG. 2, another example of the annealing process involves a slow cooldown for any number of intermediary steps with the option of a final ‘Rapid Cooling’ step. Depending on the desired resistiveness, durability, permeability, hardness, flexibility, surface aesthetic, and other qualities, one can vary the sequence of coating, force application, and cooling steps to achieve that outcome. Surface finishing can also include a baking, broiling, or abrasion step to further affect one or both sides of the surface coating and its strength, based on the time and temperature of operation whilst performing this step.

Variations on the container's substrate e.g. its design/specification, architecture, and base material), ingredient ratios of the Wax Solution, and the Coating Process variables all lead to varying, by preference, resistive, durability and aesthetic properties of the final, output, container produced through the specialized process. Some of those variables will also be described in detail with regard to Hermeticity.

Hermeticity of Containers:

When used with a biodegradable or compostable article or substrate, the Wax Solution (in concomitance with the right design of the substrate container) can achieve a hermetic seal, wherein air is unable to flow through the fused substrate container. This seal can be achieved via a post-coating heat step which lightly re-melts the coating to fuse the substrates together, forming the seal. Pressure can be added to improve the seal to various degrees of hermeticity.

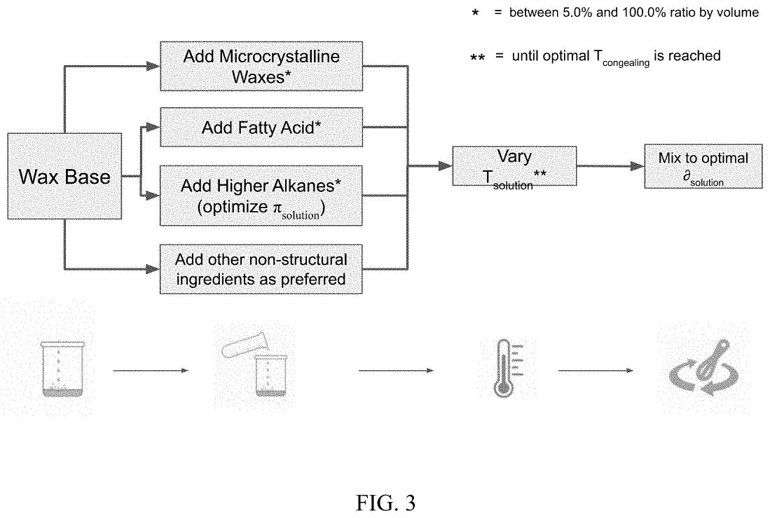

FIG. 3 is a flow chart showing how the Wax Solution is created from constituent ingredients. As seen in the flow chart, the Wax Solution is created using microcrystalline waxes, stearic acid, high alkanes and other non-structural ingredients. Ingredients of the composition can be added in various orders and mixed accordingly, depending on the Temperature (T). T is then varied so to mix the solution to an even solution distribution, ∂.

Thus, the present invention is directed to various methods of annealing an article or substrate for strength yet allowing it to be biodegradable. These processes include various formulas and methods including: 1) a method for making a biodegradable substrate resistant to various water and non-water solutions; 2) a method for improving the durability of a compostable substrate by annealing wax process; 3) a method for making a compostable substrate resistant to various water and non-water solutions; 4) various mixture ratios of wax to strengthen sealing; 5) various mixture ratios of wax to improve the durability of biodegradable or compostable substrates, 6) a method for improving the durability of biodegradable or compostable containers; 7) a method for making biodegradable or compostable substrate based containers hermetic; and 8) a method for making biodegradable or compostable containers hermetic via wax coating.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for strengthening a substrate comprising the steps of:
a) mixing a Wax Solution;
b) submerging an article in a bath of Wax Solution to apply a Coating;
c) rinsing the article in a water bath after a first predetermined time;
d) repeating steps b) and c) to achieve a desired Coating thickness;
e) baking the article under a high temperature using blown air; and
f) sealing the article by allowing it to cool for a predetermined period.

2. A method for strengthening a substrate as in claim 1, further comprising the step of:
utilizing an annealing process to achieve a desired hardness of the Coating.

3. A method for strengthening a substrate as in claim 1, further comprising the steps of:
g) rapidly cooling the article after the Coating has been applied in an annealing process;
h) repeating step g) to achieve a desired hardness; and
i) applying a surface finish.

4. A method for strengthening a substrate as in claim 2, further comprising the step of:
sealing the article if the article is a container.

5. A method for strengthening a substrate as in claim 1, further comprising the step of:
using a bottle as the article.

6. A method for strengthening a substrate as in claim 1, further comprising the step of:
using a paper tube as the article.

7. A method for strengthening a substrate as in claim 1, further comprising the step of:
using a clam-shell pulp form as the article.

8. A method for strengthening a substrate as in claim 1, further comprising the step of:
using interlocking or fused pulp forms as the article.
